(19) United States
(12) Patent Application Publication
(10) Pub. No.: US 2014/0087207 A1
(43) Pub. Date: Mar. 27, 2014

(54) ARTICLES COMPRISING A WEATHER-RESISTANT ADHESIVE LAYER IN CONTACT WITH A LOW SURFACE-ENERGY MATERIAL

(71) Applicant: E I DU PONT DE NEMOURS AND COMPANY, Wilmington, DE (US)

(72) Inventor: CHEN QIAN ZHAO, Newark, DE (US)

(21) Appl. No.: 13/930,325

(22) Filed: Jun. 28, 2013

Related U.S. Application Data
(60) Provisional application No. 61/665,937, filed on Sep. 25, 2012.

(51) Int. Cl. B32B 27/08; B32B 27/18; B32B 27/06; B32B 27/32; B32B 15/08

(52) U.S. Cl. CPC B32B 27/08; B32B 27/322; B32B 15/08; B32B 27/065; B32B 27/18
USPC 428/623; 428/421; 428/414; 428/422; 428/317.7; 428/221

(57) ABSTRACT

One aspect of the invention is a laminate article including a first substrate layer comprising a fluorine-containing surface, a second substrate layer and an adhesive layer in contact with both the fluorine-containing surface of the first substrate layer and the second substrate layer. The adhesive layer includes a cross-linkable, pressure-sensitive acrylic adhesive and a cross-linker selected from the group consisting of epoxies, polyisocyanates, and melamines.

### FIELD OF THE INVENTION

This invention relates to laminate articles comprising an adhesive layer, containing a cross-linkable pressure-sensitive acrylic, that is weather-resistant and has good adhesion to low surface energy materials.

### BACKGROUND

Fluorine-containing materials such as polytetrafluoroethylene, polyvinylidene fluoride (PVDF), and terpolymers of tetrafluoroethylene, hexafluoropropylene and vinylidene fluoride have excellent chemical and physical inertness, as well as excellent barrier properties and hydrophobic characteristics. As a result, such materials have excellent weatherability and high thermal stability. However, fluorine-containing materials are expensive and it would often be desirable to use them in combination with other materials, e.g., in laminates, to reduce costs. But fluorine-containing materials inherently have low surface energy and suffer from poor adhesion to dissimilar materials, making it difficult to form laminates. To overcome this problem, various methods for improving the adhesion properties of fluorine-containing materials have been investigated.

One approach is to modify the fluorine-containing material itself to enable its adhesion to an existing hydrocarbon material (e.g., an adhesive) via a wet or dry surface treatment of the fluorine-containing material. Alternatively, the fluoropolymer can be modified, for example, by creating a polymer blend or by dehydrofluorination.

Other efforts have focussed on developing adhesives that adhere well to fluorine-containing materials. U.S. Pat. No. 5,079,047 proposes a solventless, photoinitiated adhesive comprising, by weight, 60-95% of an alkyl acrylate, 5-40% of a copolymerizable monomer such as acrylic acid, and 10-30% ethylene vinyl acetate. U.S. Pat. No. 3,737,483 proposes a carboxylated polymer product comprising maleic anhydride polymerized with an alpha-olefin in contact with an ethylene vinyl acetate (EVA) copolymer in the presence of an organic peroxide and organic diluent. U.S. Pat. No. 3,749,756 proposes the same carboxylated polymer product without the peroxide and organic diluent. U.S. Pat. No. 4,347,341 proposes ethylene graft copolymers containing anhydride or carboxyl groups which are made from vinyl esters of monocarboxylic acid, maleic anhydride and esters thereof which are radically polymerized in the presence of 30-95% by weight of ethylene homopolymers or ethylene vinyl ester copolymers. U.S. Pat. No. 4,762,882 proposes modified polyolefin resins which consist essentially of a copolymer of ethylene and alpha-olefin and an unsaturated carboxylic acid grafted on the ethylene copolymer. U.S. Pat. No. 4,810,755 proposes an adhesive composition comprising a metal-containing composition consisting of an ethylene-(meth)acrylate copolymer grafted with an ethylenic unsaturated carboxylic acid or its acid anhydride and an ethylenic unsaturated carboxylic or its acid anhydride of a metal hydroxide. U.S. Pat. No. 4,908,411 proposes modified ethylenic random copolymers derived from ethylene alpha-olefin copolymers grafted with unsaturated carboxylic acids, styrene-type hydrocarbons, or unsaturated silanes. U.S. Pat. No. 4,917,734 proposes ethylene copolymers which have been grafted with styrene-based, vinyl, acrylic, and/or methacrylic grafting monomers. U.S. Pat. No. 4,977,212 proposes resin compositions comprising a metal-containing composition consisting of an ethylene ester copolymer and an unsaturated carboxylic acid or its acid anhydride, a saponified EVA copolymer, and a hydrophobic thermoplastic resin.

U.S. Pat. No. 6,441,114 discloses the use of amide-containing adhesives with substrates derived from hydrofluorinated monomers.

U.S. Pat. No. 7,767,752 discloses acrylic pressure-sensitive adhesives comprising an acrylic polymer, an ester plasticizer, an alkali metal salt, and a multifunctional cross-linking agent such as an isocyanate, epoxy, aziridine or metal chelate cross-linking agent.

Despite such proposals, there is still a need for adhesives that possess enhanced adhesion to low surface energy substrates such as fluorine-containing polymer substrates. There is also a need for laminated articles comprising fluorine-containing polymer substrates that are weather-resistant.

### SUMMARY

One aspect of the invention is a laminate article including a first substrate layer comprising a fluorine-containing surface, a second substrate layer and an adhesive layer in contact with both the fluorine-containing surface of the first substrate layer and the second substrate layer. The adhesive layer includes a cross-linkable, pressure-sensitive acrylic adhesive and a cross-linker selected from the group consisting of epoxies, polyisocyanates, and melamines.

### BRIEF DESCRIPTION OF THE FIGURE

FIG. 1 depicts a multilayer structure comprising an FEP layer 1, an adhesive layer 2 comprising a cross-linkable pressure-sensitive acrylic adhesive and an epoxy cross-linker, and a PET layer 4 coated on both sides with an atomic layer deposition coating of alumina 3.

### DETAILED DESCRIPTION

One aspect of the invention is a laminate article comprising:

a) a first substrate layer comprising a fluorine-containing surface;
b) a second substrate layer; and
c) an adhesive layer in contact with both the fluorine-containing surface of the first substrate layer and the second substrate layer, wherein the adhesive layer comprises:
i) a cross-linkable, pressure-sensitive acrylic adhesive; and
ii) a cross-linker selected from the group consisting of epoxies, polyisocyanates, and melamines.

Suitable first substrate layers include fluoropolymer films, fluoropolymer sheets and fluoropolymer-coated substrates. Suitable fluoropolymers include polytetrafluoroethylene (PTFE), polyvinyl fluoride (PVF), polyvinylidene fluoride (PVDF), fluorinated ethylene-propylene (FEP) copolymer, and polyethylenetetrafluoroethylene (ETFE).

Suitable second substrate layers include foamed sheets, metal sheets, fabric, polymer films and polymer sheets. Suitable polymer films and sheets include those comprising polyolefins (e.g., polyethylene or polypropylene), polyamides (e.g., nylon-6, nylon-6,6, or nylon-6,12) polyimides and polyesters (e.g., polyethylene terephthalate, polyethylene naphthalate, or polytrimethylene terephthalate). The polymer films and sheets can be coated, for example with metals (e.g., aluminum), metal oxides (e.g., aluminum oxide or indium tin oxide), or metal nitrides (e.g., silicon nitride).

The adhesive layer can be applied to either the first or second substrate layers, or both the first and second substrate layers, but typically is applied to the more robust of the two substrates. The adhesive layer, which comprises a mixture of a cross-linkable, pressure-sensitive acrylic adhesive and a cross-linker, can be applied to one or both sides of the substrate in a conventional manner, for example, by spraying, knife-coating, roller-coating, casting, drum-coating, or dipping. Indirect application using a transfer process with silicon release paper can also be used.

The adhesive layer can have any useful thickness. In some embodiments, the adhesive layer has a thickness of 25-75 micrometers, or 25-50 micrometers.

After the adhesive layer has been applied to the first and/or second substrate layer, the coated substrate can be dried at a temperature of from 75-150° C. to remove solvent or other volatile materials.

The article can be formed by conventional laminate-forming techniques. For example, a first substrate layer comprising a fluorine-containing surface can be coated with a mixture comprising the cross-linkable, pressure-sensitive acrylic adhesive and the cross-linker, followed by drying. Then the second substrate layer can be placed in contact with the dried adhesive composition to form the laminate.

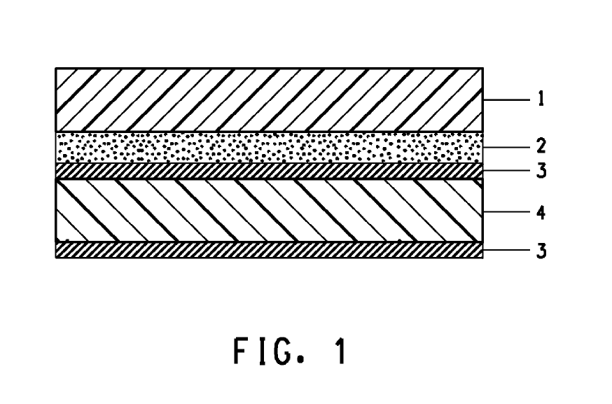

In one embodiment, as depicted in FIG. 1, a multilayer structure can comprise a fluorinated ethylene-propylene (FEP) copolymer layer 1, an adhesive layer 2 comprising a cross-linkable pressure-sensitive acrylic adhesive and an epoxy cross-linker, and a polyethylene terephthalate (PET) layer 4 coated on both sides with an atomic layer deposition (ALD) coating of alumina 3.

As used herein, the term “pressure-sensitive adhesive” refers to a viscoelastic material that adheres instantaneously to a substrate with the application of slight pressure (such as the pressure that can be applied manually by finger- or hand-pressure) and remains permanently tacky. A polymer is a pressure-sensitive adhesive within the meaning of the term as used herein if it has the properties of a pressure-sensitive adhesive per se, or functions as a pressure-sensitive adhesive by admixture with tackifiers, plasticizers or other additives. The term “pressure-sensitive adhesive” is known and well understood by one of ordinary skill in the art, and the use of the term herein should not differ substantially from the ordinary meaning that the term has obtained in the art.

Acrylic pressure-sensitive adhesives are copolymers that generally comprise a primary component consisting of an acrylate or methacrylate monomer or a combination of such monomers which, when polymerized, have a low glass transition temperature (Tg) and a low elastic modulus (i.e., they are rubbery and soft). These soft, tacky, low Tg monomers are typically copolymerized with a secondary component consisting of high Tg monomers, e.g., polar monomers such as acrylic acid, methacrylic acid, itaconic acid, acrylamide, methacrylamide, or mixtures thereof. When such polar monomers are incorporated with a predominance of low Tg monomers, a sufficiently tacky pressure-sensitive adhesive is formed having high cohesive or internal strength. In addition to the secondary comonomers, monomers with functional groups are typically incorporated to provide cross-linking sites or to modify certain properties of the adhesive. The purpose of the cross-linking sites is to increase the internal or cohesive strength (i.e., shear strength) via cross-linking, e.g., with epoxides.

Typically, a cross-linkable, pressure-sensitive adhesive suitable for use in the practice of the present invention (also referred to herein as “the adhesive”) is prepared by copolymerization of one or more low Tg alkyl acrylates. “Low Tg monomers” are those which form a homopolymer having a Tg of less than about 0° C. Typically, the adhesive comprises 90-99.9 wt % of one or more C₁-C₁₈ alkyl(meth)acrylic ester monomers and 0.1-10 wt % of a vinyl and/or acrylic monomer having a functional group capable of cross-linking. In some embodiments, the adhesive comprises C₄-C₁₀ alkyl(meth)acrylic esters.

As used herein, “(meth)acrylates” encompasses both acrylates and methacrylates, “(meth)acrylic” encompasses both acrylic and methacrylic, and “(meth)acrylamide” refers to both acrylamide and methacrylamide.

Suitable C₁-C₁₈ alkyl(meth)acrylic ester monomers include butyl(meth)acrylate, 2-ethylhexyl(meth)acrylate, n-propyl(meth)acrylate, isopropyl(meth)acrylate, t-butyl(meth)acrylate, pentyl(meth)acrylate, n-octyl(meth)acrylate, isooctyl(meth)acrylate, isononyl(meth)acrylate, 2-methyl butyl acrylate, amyl(meth)acrylate, hexyl(meth)acrylate, decyl(meth)acrylate, dodecyl(meth)acrylate, isodecyl acrylate, and isomers and mixtures and derivatives thereof.

Suitable low Tg monomers include C₁-C₁₈ alkyl(meth)acrylic ester monomers selected from the group consisting of ethyl acrylate, butyl acrylate, 2-ethylhexyl(meth)acrylate, n-propyl acrylate, isopropyl acrylate, isobutyl acrylate, pentyl(meth)acrylate, n-octyl(meth)acrylate, isooctyl(meth)acrylate, isononyl(meth)acrylate, 2-methyl butyl acrylate, hexyl(meth)acrylate, decyl(meth)acrylate, dodecyl(meth)acrylate, isodecyl acrylate, 2-ethoxyethyl acrylate, 3-ethoxyethyl acrylate, 2-ethylbutyl acrylate, 1H,1H-heptafluorobutyl acrylate, 5,5,6,6,7,7,7-heptafluoro-3-oxaheptyl acrylate, 2,2,3,3,5,5,5,-heptafluoro-4-oxapentyl acrylate, heptyl acrylate, 2-heptyl acrylate, 1H,1H,3H-hexafluorobutyl acrylate, 3-methoxybutyl acrylate, 2-methoxyethyl acrylate, 3-methoxypropyl acrylate, 2-methylbutyl acrylate, 3-methylbutyl acrylate, 2-methyl-7-ethyl-4-undecyl acrylate, 1H,1H-nonafluoro-4-oxahexyl acrylate, 1H,1H-nonafluoropentyl acrylate, nonyl acrylate, 1H,1H,5H-pentafluoropentyl acrylate, 1H,1H-pentadecafluorooctyl acrylate, 1H,1H-pentafluoropropyl acrylate, n-pentyl acrylate, 3-pentyl acrylate, 7,7,8,8-tetrafluoro-3,6-dioxaoctyl acrylate, 4,4,5,5-tetrafluoro-3-oxapentyl acrylate, 2,2,2-trifluoroethyl acrylate, 5,5,5-trifluoro-3-oxapentyl acrylate, 1H,1H-tridecafluoro-4-oxaoctylacrylate, 1H,1H-undecafluorohexyl acrylate, 1H,1H-undecafluoro-4-oxahexyl acrylate, 1H,1H,9H-hexadecafluorononyl methacrylate, octadecyl methacrylate, tetradecyl methacrylate, and mixtures thereof.

A cross-linkable, pressure-sensitive acrylic adhesive suitable for use in the practice of the present invention can also comprise high Tg monomers, i.e., those monomers that form homopolymers with a Tg greater than 0° C. Suitable high Tg monomers include C₁-C₁₈ alkyl(meth)acrylic ester monomers selected from the group consisting of ethyl methacrylate, methyl(meth)acrylate, vinyl acetate, tert-butyl acrylate, hexadecyl(meth)acrylate, neopentyl acrylate, tetradecyl acrylate, butyl methacrylate, 3,3-dimethylbutyl methacrylate, 3,3-dimethyl-2-butyl methacrylate, isobutyl methacrylate, isopropyl methacrylate, neopentyl methacrylate, propyl methacrylate, 3,5,5-trimethylhexyl methacrylate, cyclobutyl methacrylate, cylcodecyl methacrylate, cyclododecyl methacrylate, cyclohexyl(meth)acrylate, cyclooctyl methacylate, cyclooctylmethyl methacrylate, cyclopentyl methacrylate, 1H,1H,7H-dodecafluoroheptyl methacrylate, 3-fluoroalkyl(meth)acrylate, 4-fluoroalkyl(meth)acrylate, 5-fluoroalkyl(meth)acrylate, 8-fluoroalkyl(meth)acrylate, 17-fluoroalkyl(meth)acrylate, fluoromethyl acrylate, heptafluoro-2-propyl acrylate, 1H,1H-heptafluorobutyl methacrylate, 1H,1H,5H-octafluoropentyl methacrylate, 3-oxabutyl methacrylate, 3-tetracyclododecyl methacrylate, 1,1,1-trifluoro-2-propyl methacrylate, 3,3,5-trimethylcyclohexyl(meth)acrylate, and mixtures thereof. The high Tg monomers typically comprise 0-50 wt %, or 5-50 wt %, or 10-40 wt % of the adhesive.

Use of a cross-linking agent and vinyl or acrylic monomers having a functional group capable of cross-linking provides adhesive compositions with improved cohesive- or peel-strength under high temperature and/or high humidity conditions.

In addition to the low and optional high Tg monomers, the adhesive useful herein comprises 0.1-10 wt % of a vinyl or acrylic monomer having a functional group capable of being cross-linked. Suitable such monomers include: hydroxy-containing monomers such as 2-hydroxyethyl(meth)acrylate, 2-hydroxypropyl(meth)acrylate, 4-hydroxybutyl(meth)acrylate, 2-hydroxyethyleneglycol(meth)acrylate, and 2-hydroxypropyleneglycol(meth)acrylate; and carboxylic acid-containing (also referred to herein as carboxy-containing) monomers such as (meth)acrylic acid, acrylic acid dimer, itaconic acid, maleic acid, and maleic anhydride.

Hydroxy-containing monomers typically comprise 1-10 wt % of the cross-linkable, pressure-sensitive adhesive. Carboxy-containing monomers typically comprise 0-10 wt %, or 1-5 wt %, of the adhesive.

Other comonomers can be used to modify the Tg of the adhesive to enhance adhesion to specific surfaces and/or to improve high temperature shear properties. In some embodiments, the adhesive comprises repeat units derived from monomers such as N-vinyl pyrrolidone, N-vinyl caprolactam, N-alkyl(meth)acrylamides such as t-octylacrylamide, cyanoethylacrylates, diacetoneacrylamide, N-vinyl acetamide, N-vinyl is formamide, allyl glycidyl ether, acrylonitrile, (meth)acrylamide, styrene, methylstyrene, vinyltoluene, glycidyl(meth)acrylate, vinylacetate, or mixtures thereof.

Suitable cross-linkable, pressure-sensitive acrylic copolymers useful herein as adhesives can be prepared by standard polymerization processes from the monomers described above. Suitable methods for preparing the copolymers include: solution polymerization, photo-polymerization, bulk polymerization, suspension polymerization, and emulsion polymerization.

In addition, a wide variety of suitable acrylic adhesives are available commercially, e.g., Aroset® 1860, self-cross-linking acrylic polymer (Ashland Inc., Columbus, Ohio), and Duro-Tak® 80-216A, a high solids acrylic pressure-sensitive adhesive (Henkel Co., Bridgewater, N.J.).

In some embodiments, the cross-linkable, pressure-sensitive acrylic adhesive is a rubber-acrylic graft polymer comprising an acrylic polymer backbone grafted with rubber macromers. Suitable rubber macromers include: ethylene-butylene macromers, ethylene-propylene macromers and ethylene-butylene-propylene macromers. In general, the graft polymers are made by copolymerizing alkyl acrylate ester monomers in the presence of a macromer containing a reactive acrylic or methacrylic end group. This leads to a comb-type copolymer having an acrylic backbone and side chains of macromer.

More specifically, the acrylic polymer backbone of the graft copolymer is typically formed from one or more low Tg alkyl acrylates. Suitable low Tg alkyl acrylates have 2-18 carbon atoms, or 4-10 carbon atoms, in the alkyl group. Suitable low Tg alkyl acrylates include ethyl acrylate, butyl acrylate, 2-ethylhexyl(meth)acrylate, n-propyl acrylate, isopropyl acrylate, isobutyl acrylate, pentyl(meth)acrylate, n-octyl(meth)acrylate, isooctyl(meth)acrylate, isononyl(meth)acrylate, 2-methyl butyl acrylate, hexyl(meth)acrylate, decyl(meth)acrylate, dodecyl(meth)acrylate, isodecyl acrylate, 2-ethoxyethyl acrylate, 3-ethoxyethyl acrylate, 2-ethylbutyl acrylate, 1H,1H-heptafluorobutyl acrylate, 5,5,6,6,7,7,7-heptafluoro-3-oxaheptyl acrylate, 2,2,3,3,5,5,5-heptafluoro-4-oxapentyl acrylate, heptyl acrylate, 2-heptyl acrylate, 1H,1H,3H-hexafluorobutyl acrylate, 3-methoxybutyl acrylate, 2-methoxyethyl acrylate, 3-methoxypropyl acrylate, 2-methylbutyl acrylate, 3-methylbutyl acrylate, 2-methyl-7-ethyl-4-undecyl acrylate, 1H,1H-nonafluoro-4-oxahexyl acrylate, 1H,1H-nonafluoropentyl acrylate, nonyl acrylate, 1H,1H,5H-pentafluoropentyl acrylate, 1H,1H-pentadecafluorooctyl acrylate, 1H,1H-pentafluoropropyl acrylate, n-pentyl acrylate, 3-pentyl acrylate, 7,7,8,8-tetrafluoro-3,6-dioxaoctyl acrylate, 4,4,5,5-tetrafluoro-3-oxapentyl acrylate, 2,2,2-trifluoroethyl acrylate, 5,5,5-trifluoro-3-oxapentyl acrylate, 1H,1H-tridecafluoro-4-oxaoctylacrylate, 1H,1H-undecafluorohexyl acrylate, 1H,1H-undecafluoro-4-oxahexyl acrylate, 1H,1H,9H-hexadecafluorononyl methacrylate, octadecyl methacrylate, tetradecyl methacrylate, isomers and combinations thereof.

The monomers used to make the acrylic backbone can consist essentially of low Tg alkyl acrylate ester monomers, but it is more typical to include some high Tg monomers and/or functional comonomers, such as carboxy-containing functional monomers and/or hydroxy-containing functional monomers.

High Tg monomers suitable for incorporation into the backbone include ethyl methacrylate, methyl(meth)acrylate, vinyl acetate, tert-butyl acrylate, hexadecyl(meth)acrylate, neopentyl acrylate, tetradecyl acrylate, butyl methacrylate, 3,3-dimethylbutyl methacrylate, 3,3-dimethyl-2-butyl methacrylate, isobutyl methacrylate, isopropyl methacrylate, neopentyl methacrylate, propyl methacrylate, 3,5,5-trimethylhexyl methacrylate, cyclobutyl methacrylate, cylcodecyl methacrylate, cyclododecyl methacrylate, cyclohexyl(meth)acrylate, cyclooctyl methacylate, cyclooctylmethyl methacrylate, cyclopentyl methacrylate, 1H,1H,7H-dodecafluoroheptyl methacrylate, 3-fluoroalkyl(meth)acrylate, 4-fluoroalkyl(meth)acrylate, 5-fluoroalkyl(meth)acrylate, 8-fluoroalkyl(meth)acrylate, 17-fluoroalkyl(meth)acrylate, fluoromethyl acrylate, heptafluoro-2-propyl acrylate, 1H,1H-heptafluorobutyl methacrylate, 1H,1H,5H-octafluoropentyl methacrylate, 3-oxabutyl methacrylate, 3-tetracyclododecyl methacrylate, 1,1,1-trifluoro-2-propyl methacrylate, 3,3,5-trimethylcyclohexyl(meth)acrylate, and mixtures thereof. The high Tg monomers can be present in a total amount of 0.1-50 wt %, or 5-50 wt %, or 10-40 wt %, based on the total weight of the acrylic polymer backbone.

Carboxy functional monomers can be incorporated into the backbone in an amount of 0.1-7 wt %, or 1-5 wt %, based on the total weight of the monomers. Suitable carboxy functional monomers include (meth)acrylic acid, itaconic acid, and mixtures thereof.

In some embodiments, the acrylic backbone comprises hydroxy functional monomers such as hydroxyalkyl(meth)acrylate esters. Specific examples of hydroxy functional monomers include hydroxyethyl acrylate, hydroxypropyl acrylate, hydroxyethyl methacrylate and hydroxypropyl methacrylate. Hydroxy functional monomers are generally used in an amount of from about 1-10 wt %, or from about 3-7 wt %, based on the total weight of the acrylic backbone.

Other suitable comonomers include N-vinyl pyrrolidone, N-vinyl caprolactam, N-alkyl(meth)acrylamides such as t-octyl acrylamide, cyanoethylacrylates, diacetoneacrylamide, N-vinyl acetamide, N-vinyl formamide, glycidyl methacrylate and allyl glycidyl ether.

The monomer proportions of the acrylic polymer are adjusted in such a way that the backbone polymer has a glass transition temperature of less than about −10° C., or from about −20° C. to about −60° C.

The macromers used to prepare the graft copolymers have a glass transition temperature of about −30° C. or less, or from about −50° C. to about −70° C., as determined by differential scanning calorimetry (DSC). They are typically present in an amount of from about 5-50 wt % of the graft polymer. Suitable molecular weights of the macromer are from about 2,000 to about 30,000, or from 2,000 to about 10,000, as determined by gel permeation chromatography (GPC). Examples of such macromers are commercially available from Kraton Polymers Company (Houston, Tex.).

The macromers can also be prepared by a number of well-known methods. One method involves an anionic polymerization to produce a hydroxyl-terminated conjugated diene polymer formed from, for example, 1,3-butadiene and/or isoprene monomer, as described in U.S. Pat. No. 5,625,005. Reduction of at least 90%, alternatively at least 95%, of the unsaturation in the low molecular weight mono-ol can be achieved through catalytic hydrogenation, as taught in U.S. Pat. Nos. Re. 27,145 and 4,970,254.

Suitable saturated rubber mono-ols, such as Kraton® L 1203, are also available from Kraton Polymers Company.

In the final step, the hydroxyl termination is reacted to form an acrylate or methacrylate group via: esterification or transesterification using a strong acid or metal-containing catalyst (e.g., compounds of Ti or Sn); by reaction with an acid chloride; or a urethane reaction employing a metal catalyst, as described in U.S. Pat. No. 5,625,005.

In some embodiments, the cross-linkable, pressure-sensitive adhesive has an inherent viscosity in a range of 0.3 dl/g or greater, or from 0.3-2.0 dl/g, or from 0.7-2.0 dl/g. In some embodiments, the adhesive has a glass transition temperature of −10° C. or less, or from −70 to −20° C., and a 180° peel adhesion test value in a range of 5-40 oz/in, or 7-25 oz/in, or 10-20 oz/in. In some embodiments, the adhesive layer has a 30 minute gap test value of 3 mm or less, or 2 mm or less, and a haze test value of less than 10%, or less than 5%, or less than 2%. In some embodiments, the pressure-sensitive adhesive layer is colorless as defined by the CIELAB color scale, with an L* value of 95 or more, and a* and b* values between −0.7 and +0.7.

In some embodiments, the molecular weight of the adhesive is 800,000-2,000,000. Although there are many factors that contribute to the properties of an adhesive, it is generally believed that tack and resistance to peel increase with increasing molecular weight until a maximum is reached. This maximum is at a fairly low molecular weight. Adhesives that contain higher molecular weight polymers tend to have more cohesive strength, but lower adhesive strength.

In some embodiments, it may be advantageous to reduce the residual monomer content and amount of reaction residues from the adhesive to minimize bubble generation. When the elastic modulus of a pressure-sensitive adhesive is too low, as might result from low cross-linking density and/or low molecular weight, bubbles can be generated between the substrate and the pressure-sensitive adhesive layer at high temperature. On the other hand, excessive cross-linking can lead to an adhesive with a high elastic modulus, and edge lifting may be observed at the end of the adhesive layer.

In some embodiments, the adhesive layer comprises 0.5-10 wt % of an epoxide cross-linker. Epoxide resins useful as cross-linkers are any organic compounds having at least one oxirane ring,

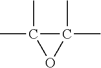

that is polymerizable by a ring-opening reaction. Such materials, broadly called epoxides, include both monomeric and polymeric epoxides and can be aliphatic, heterocyclic, cycloaliphatic, or aromatic. They can be liquid or solid or blends thereof. The epoxide resins generally have at least two epoxy groups per molecule and are also called “polyepoxides”. The polyepoxides include: linear polymers having terminal epoxy groups (e.g., a diglycidyl ether of a polyoxyalkylene glycol); polymers having skeletal oxirane units (e.g., polybutadiene polyepoxide); and polymers having pendent epoxy groups (e.g., a glycidyl methacrylate polymer or copolymer). In some embodiments, the molecular weight of the epoxide resin is about 74 to about 100,000. In some embodiments, the molecular weight is more than 100,000.

Epoxide resins suitable for use in the practice of the present invention include those which contain cyclohexene oxide groups such as the epoxycyclohexane carboxylates, exemplified by: 3,4-epoxycyclohexylmethyl-3,4-epoxycyclohexane carboxylate; 3,4-epoxy-2-methylcyclohexylmethyl-3,4-epoxy-2-methycyclohexane carboxylate; bis(3,4-epoxy-6-methylcyclohexylmethyl)adipate; 3-methyl-1,5-pentanediol bis(3,4-epoxycyclohexanecarboxylate); 1,5-pentanediol bis(3,4-epoxycyclohexanecarboxylate); 2-methoxymethyl-2,4-dimethyl-1,5-pentanediol bis(3,4-epoxycyclohexanecarboxylate); ethylene glycol bis(3,4-epoxycyclohexanecarboxylate); 2,2-diethyl-1,3-propanediol bis(3,4-epoxycyclohexanecarboxylate); 1,6-hexanediol bis(3,4-epoxycyclohexanecarboxylate); 2-butene-1,4-diol bis(3,4-epoxy-6-methylcyclohexanecarboxylate); 1,1,1-trimethylolpropane tris(3,4-epoxycyclohexanecarboxylate); and 1,2,3-propanetriol tris(3,4-epoxycyclohexanecarboxylate).

Suitable epoxides also include oxyalkylene glycol epoxycyclohexanecarboxylates exemplified by: dipropylene gylcol bis(2-ethylhexyl 4,5-epoxycyclohexane-1,2-dicarboxylate); diethylene glycol bis(3,4-epoxy-6-methylcyclohexanecarboxylate); and triethylene glycol bis(3,4-epoxycyclohexanecarboxylate).

Suitable epoxides also include epoxycyclohexylalkyl epoxycyclohexanecarboxylates exemplified by: 3,4-epoxycycicohexylmethyl 3,4-epoxycyclohexanecarboxylate; 3,4-epoxy-1-methylcyclohexylmethyl 3,4-epoxy-1-methylcyclohexanecarboxylate; 3,4-epoxy-2-methylcyclohexylmethyl 3,4-epoxy-2-methyl-cyclohexanecarboxylate; (1-chloro-3,4-epoxycyclohexan-1-yl)methyl 1-chloro-3,4-epoxycyclohexanecarboxylate; (1-bromo-3,4-epoxycyclohexan-1-yl)methyl 1-bromo-3,4-epoxycyclohexanecarboxylate; and (1-chloro-2-methyl-4,5-epoxycyclohexan-1-yl)methyl 1-chloro-2-methyl-4,5-epoxycyclohexanecarboxylate.

Suitable epoxides also include: bis(3,4-epoxycyclohexylmethyl)pimelate; bis(3,4-epoxy-6-methylcyclohexylmethyl)maleate; bis(3,4-epoxy-6-methylcyclohexylmethyl)succinate; bis(3,4-epoxycyclohexylmethyl)oxalate; bis(3,4-epoxy-6-methylcyclohexylmethyl)sebacate; bis(3,4-epoxycyclohexylmethyl)terephthalate; bis(3,4-epoxy-6-methylcyclohexylmethyl)terephthalate; bis(3,4-epoxy-6-methylcyclohexylmethyl)diethylene glycol ether; 2,2′-sulfonyldiethanol bis(3,4-epoxycyclohexanecarboxylate); N,N′-ethylene bis(4,5-epoxycyclohexane-1,2-dicarboximide); di(3,4-epoxycyclohexylmethyl) 1,3 tolylenedicarbamate; bis(3,4-epoxy-6-methylcyclohexylmethyl) 3,4-epoxy-6-methylcyclohexanecarboxaldehyde acetal; vinyl cyclohexene dioxide; vinyl cyclohexene monoxide; 3,4-epoxycyclohexylmethyl acrylate; 3,4-epoxy-6-methylcyclohexylmethyl 9,10-epoxystearate; 1,2-bis(2,3-epoxy-2-methylpropoxy)ethane; and 3,9-bis(3,4-epoxycyclohexyl)spiro-bi(meta-dioxane).

Suitable epoxides also include cyclopentene oxides, such as: bis(2,3-epoxycyclopentyl)ether; dicyclopentadiene dioxide; glycidyl 2,3-epoxycyclopentyl ether; 2,3-epoxycyclopentyl 2-methyl-glycidyl ether; 2,3-epoxycyclopentyl acrylate; 2,3-epoxycyclopentyl cyclopentyl ether; 2,3-epoxycyclopentyl phenyl ether; 2,3-epoxycyclopentyl 2-cyclopentenyl ether; 2,3-epoxycyclopentyl crotonate; allyl 2,3-epoxycyclopentyl ether; 2,3-epoxycyclopentanol; and dicyclopentadiene monoxide.

Suitable epoxide resins also include glycidyl ether monomers of the formula:

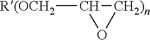

where R′ is an alkyl, aryl, alkaryl, or aryl-substituted alkyl group, and n is an integer of 1 to 6. Examples include glycidyl ethers of polyhydric phenols such as the diglycidyl ether of 2,2-bis-(4-hydroxyphenol)propane (Bisphenol A), and copolymers of (chloromethyl)oxirane and 4,4′-(1-methylethylidene)bisphenol.

Suitable epoxides also include polyepoxides such as: epoxidized mono-, di-, and triglycerides; butadiene dioxide; 1,4-bis(2,3-epoxypropoxy)benzene; 1,3-bis(2,3-epoxypropoxy)benzene; 4,4′-bis(2,3-epoxypropoxy)diphenyl ether; 1,8-bis(2,3-epoxypropoxy)octane; 1,4-bis(2,3-epoxypropoxy)cyclohexane; 4,4′-bis(2-hydroxy-3,4-epoxybutoxy)diphenyldimethylmethane; 1,3-bis(4,5-epoxypentoxy)-5-chlorobenzene; 1,4-bis(3,4-epoxybutoxy)-2-chlorocyclohexane; diglycidyl thioether; diglycidyl ether; ethylene glycol diglycidyl ether; resorcinol diglycidyl ether; 1,2,5,6-diepoxy-hexyne-3; 1,2,5,6-diepoxyhexane; and 1,2,3,4-tetra(2-hydroxy-3,4-epoxybutoxy)butane.

Suitable commercially available epoxide resins include: styrene oxide; vinylcyclohexene oxide; glycidol; glycidyl methacrylate; diglycidyl ethers of Bisphenol A (e.g., “EPON 828,” “EPON 1004,” and “EPON 1001F” from Shell Chemical Company, and “DER-332” and “DER-334” from Dow Chemical Company); diglycidyl ethers of Bisphenol F (e.g., “ARALDITE GY281” from Ciba-Geigy Corporation, and “EPON 862” from Shell Chemical Company); vinylcyclohexane dioxide (e.g., “ERL-4206” from Union Carbide Corporation); 3,4-epoxycyclohexyl-methyl-3,4-epoxycyclohexene carboxylate (e.g., “ERL-4221” from Union Carbide Corporation); 2-(3,4-epoxycyclohexyl-5,5-spiro-3,4-epoxy)cyclohexane-metadioxane (e.g., “ERL-4234” from Union Carbide Corporation); bis(3,4-epoxycyclohexyl)adipate (e.g., “ERL-4299” from Union Carbide Corporation); dipentene dioxide (e.g., “ERL-4269” from Union Carbide Corporation); epoxidized polybutadiene (e.g., “OXIRON 2001” from FMC Corporation); flame retardant epoxide resins (e.g., “DER-542,” a brominated bisphenol-type epoxy resin available from Dow Chemical Company); 1,4-butanediol diglycidyl ether (e.g., “ARALDITE RD-2” from Ciba-Geigy Corporation); diglycidyl ether of hydrogenated Bisphenol A based epoxide resins (e.g., “EPONEX 1510” from Shell Chemical Company); and polyglycidyl ethers of phenol-formaldehyde novolak (e.g., “DEN-431” and “DEN-438” from Dow Chemical Company).

Isocyanate cross-linkers suitable for use in the practice of the present invention include aliphatic, aromatic and cycloaliphatic di- and polyisocyanates having an average NCO functionality of at least 1.8, or from 1.8 to 5, or from 2 to 4, and also their derivatives such as isocyanurates, oxadiazinetriones, iminooxadiazinediones, ureas, biurets, amides, urethanes, allophanates, carbodiimides, uretonimines and uretdiones.

Suitable diisocyanates include isocyanates having 4-20 carbon atoms. Specific examples include: aliphatic diisocyanates such as tetramethylene diisocyanate, hexamethylene diisocyanate (1,6-diisocyanatohexane), octamethylene diisocyanate, decamethylene diisocyanate, dodecamethylene diisocyanate, tetradecamethylene diisocyanate, derivatives of lysine diisocyanate, trimethylhexane diisocyanate and tetramethylhexane diisocyanate; cycloaliphatic diisocyanates such as 1,4-, 1,3- and 1,2-diisocyanatocyclohexane, 4,4′- and 2,4′-di(isocyanatocyclohexyl)-methane, 1-isocyanato-3,3,5-trimethyl-5-(isocyanatomethyl)cyclohexane(isophorone diisocyanate), 1,3- and 1,4-bis(isocyanatomethyl)cyclohexane, and 2,4- and 2,6-diisocyanato-1-methylcyclohexane; and aromatic diisocyanates such as 2,4- and 2,6-tolylene diisocyanate and isomer mixtures thereof, m- and p-xylylene diisocyanate, 2,4′- and 4,4′-diisocyanatodiphenylmethane and isomer mixtures thereof, 1,3- and 1,4-phenylene diisocyanate, 1-chloro-2,4-phenylene diisocyanate, 1,5-naphthylene diisocyanate, diphenylene 4,4′-diisocyanate, 4,4′-diisocyanato-3,3′-dimethylbiphenyl, 3-methyldiphenylmethane 4,4′-diisocyanate, tetramethylxylylene diisocyanate, 1,4-diisocyanatobenzene and diphenyl ether 4,4′-diisocyanate. Mixtures of these diisocyanates can also be used.

Suitable polyisocyanates include polyisocyanates containing isocyanurate groups, uretdione diisocyanates, polyisocyanates containing biuret groups, polyisocyanates containing amide groups, polyisocyanates containing urethane or allophanate groups, polyisocyanates comprising oxadiazinetrione groups or iminooxadiazinedione groups, carbodiimide- or uretonimine-modified polyisocyanates of linear or branched C₄-C₂₀ alkylene diisocyanates, cycloaliphatic diisocyanates having a total of 6 to 20 carbon atoms or aromatic diisocyanates having a total of 8 to 20 carbon atoms, or mixtures thereof.

Suitable di- and polyisocyanates typically have an isocyanate group content (calculated as NCO, molecular weight=42) of from 1% to 60% by weight, based on the diisocyanate and polyisocyanate (mixture), or from 2% to 60% by weight, or from 10% to 55% by weight.

Suitable cross-linkers include:

1) isocyanurate-group-containing polyisocyanates of aromatic, aliphatic and/or cycloaliphatic diisocyanates, including aliphatic and/or cycloaliphatic isocyanato-isocyanurates and those based on hexamethylene diisocyanate and isophorone diisocyanate. Isocyanurates include tris-isocyanatoalkyl and/or tris-isocyanatocycloalkyl isocyanurates, which represent cyclic trimers of the diisocyanates, or are mixtures with their higher homologues containing more than one isocyanurate ring. The isocyanato-isocyanurates generally have an NCO content of from 10% to 30% by weight, or from 15% to 25% by weight, and an average NCO functionality of from 2.6 to 4.5.

2) Uretdione diisocyanates containing aromatically, aliphatically and/or cycloaliphatically attached isocyanate groups, including those derived from hexamethylene diisocyanate or isophorone diisocyanate. Uretdione diisocyanates are cyclic dimerization products of diisocyanates. The uretdione diisocyanates can be used in a mixture with other polyisocyanates, especially those mentioned under 1).

3) Polyisocyanates containing biuret groups and aromatically, cycloaliphatically or aliphatically attached isocyanate groups, especially tris(6-isocyanatohexyl)biuret or its mixtures with its higher homologues. These polyisocyanates containing biuret groups generally have an NCO content of from 18% to 23% by weight and an average NCO functionality of from 2.8 to 4.5.

4) Polyisocyanates containing urethane and/or allophanate groups and aromatically, aliphatically or cycloaliphatically attached isocyanate groups, such as may be obtained, for example, by reacting excess amounts of hexamethylene diisocyanate or of isophorone diisocyanate with monohydric or polyhydric alcohols such as for example methanol, ethanol, isopropanol, n-propanol, n-butanol, isobutanol, sec-butanol, tert-butanol, n-pentanol, n-hexanol, n-heptanol, n-octanol, n-decanol, n-dodecanol (lauryl alcohol), 2-ethylhexanol, stearyl alcohol, cetyl alcohol, lauryl alcohol, ethylene glycol monomethyl ether, ethylene glycol monoethyl ether, 1,3-propanediol monomethyl ether, cyclopentanol, cyclohexanol, cyclooctanol, cyclododecanol or polyhydric alcohols as listed above for the polyesterols, or mixtures thereof. These polyisocyanates containing urethane and/or allophanate groups generally have an NCO content of from 12% to 20% by weight and an average NCO functionality of from 2.5 to 4.5.

5) Polyisocyanates comprising oxadiazinetrione groups, e.g., those derived from hexamethylene diisocyanate or isophorone diisocyanate.

6) Polyisocyanates comprising iminooxadiazinedione groups, such as those derived from hexamethylene diisocyanate or isophorone diisocyanate.

7) Carbodiimide-modified and/or uretonimine-modified polyisocyanates.

The isocyanate groups of the di- or polyisocyanates can also be in blocked form. Examples of suitable blocking agents for NCO groups include oximes, phenols, imidazoles, pyrazoles, pyrazolinones, triazoles, diketopiperazines, caprolactam, malonic esters or compounds as specified in the publications by Z. W. Wicks, Prog. Org. Coat. 3 (1975) 73-99 and Prog. Org. Coat 9 (1981), 3-28, by D. A. Wicks and Z. W. Wicks, Prog. Org. Coat. 36 (1999), 148-172 and Prog. Org. Coat. 41 (2001), 1-83 and also in Houben-Weyl, Methoden der Organischen Chemie, Vol, XIV/2, 61 ff. Georg Thieme Verlag, Stuttgart 1963.

By “blocking” or “capping” agents are meant compounds which transform isocyanate groups into blocked (or “capped” or “protected”) isocyanate groups that do not display the usual reactions of a free isocyanate group below a temperature known as the “deblocking temperature.” Compounds with blocked isocyanate groups are commonly employed in dual-cure coating materials or in powder coating materials which are cured to completion via isocyanate curing.

Suitable melamines are those which are obtainable by reacting melamine with aldehydes, and are often referred to as “melamine resins.”

Melamine-formaldehyde resins are products from the reaction of melamine with formaldehyde and optionally other aldehydes. If desired, the resulting methylol groups can be modified by etherification with monohydric or polyhydric alcohols. The melamine-formaldehyde resins can also be modified by reaction with amines, aminocarboxylic acids or sulfites.

Suitable aldehydes include formaldehyde, acetaldehyde, isobutyraldehyde and glyoxal.

The action of formaldehyde on mixtures of melamine and urea or on mixtures of melamine and phenol produces, respectively, melamine-urea-formaldehyde resins and melamine-phenol-formaldehyde resins which can likewise be used as cross-linkers for the adhesive composition.

Examples of suitable melamine-formaldehyde resins include monomeric or polymeric melamine resins and partly or fully alkylated melamine resins, urea resins, e.g., methylolureas such as formaldehyde-urea resins, and alkoxyureas such as butylated formaldehyde-urea resins.

The adhesive layer can also be tackified. Hydrogenated hydrocarbon resins are especially useful when long-term resistance to oxidation and ultraviolet light exposure is required. Suitable hydrogenated resins include: the Escorez 5000 series of hydrogenated cycloaliphatic resins from Exxon; hydrogenated C₉ and/or C₅ resins such as the Arkon® P series of resins by Arakawa Chemical; hydrogenated aromatic hydrocarbon resins such as Regalrez 1018, 1085 and the Regalite® R series of resins from Hercules Specialty Chemicals. Other useful resins include hydrogenated polyterpenes such as Clearon® P-105, P-115 and P-125 from the Yasuhara Yushi Kogyo Company of Japan.

The adhesive layer optionally comprises from about 25-75 wt % of an organic solvent in which the other components of the adhesive layer can be dissolved. Suitable solvents include alcohols (e.g., ethanol, propanol, isopropanol, butanol, methyl cellusolve, butyl cellusolve, and 4-hydroxy-4-methyl-2-pentanone); esters solvents such as ethyl acetate and butyl acetate; ketone solvents such as methyl ethyl ketone and cyclohexanone; and hydrocarbon solvents such as hexane, cyclohexane, heptane, benzene, xylene, and toluene.

In some embodiments, the adhesive layer also comprises additives such as wetting agents, pigments, antioxidants, ultraviolet absorbers, antistatic agents, lubricants, fillers, opacifying agents, anti-foam agents, and heat- and light-stabilizers, e.g., hindered amines. When present, the additives comprise in total less than 10 wt % of the adhesive layer.

In some embodiments, the adhesive layer comprises: an adhesive with an inherent viscosity in a range of 0.7-2.0 dl/g; 0.1-3.0 parts of a cross-linker; and 15 to 50 parts of a tackifier compatible with the adhesive.

In other embodiments, the adhesive layer comprises 100 parts of an adhesive having an inherent viscosity in a range of 0.3 to 0.7 dl/g; 0.2 to 5.0 parts of a cross-linker; and 5 to 40 parts of a tackifier compatible with the adhesive.

In further embodiments, the adhesive layer comprises 100 parts of an adhesive having an inherent viscosity in a range of 1.5 to 2.0 dl/g; 0.2 to 0.8 parts of a cross-linker; and 20 to 50 parts of a tackifier compatible with the adhesive.

In another embodiment, the adhesive layer comprises 100 parts of an adhesive having an inherent viscosity in a range of 0.5 to 1.0 dl/g; 0.4 to 1.0 parts of a cross-linker; and 10 to 35 parts of a tackifier compatible with the adhesive.

The formulation of the adhesive layer is typically prepared by thoroughly mixing the cross-linkable pressure-sensitive acrylic adhesive, the cross-linker, and the optional solvents, plasticizers, and additives. The mixing can be carried out using standard techniques and equipment.

### EXAMPLES

### General

The following materials are referred to in the Examples, and are identified here.

Aroset® 1860, self-cross-linking acrylic polymer (Ashland Inc., Columbus, Ohio), 44-47% non-volatiles.

D.E.R.™ 732 liquid epoxy resin, reaction product of epichlorohydrin and polypropylene glycol (Dow Chemical Company, Midland, Mich.), 100% solids.

Duro-Tak® 80-216A, high solids acrylic pressure-sensitive adhesive (Henkel Co., Bridgewater, N.J.), 50% solids.

Eponex™ 1510, Cyclohexanol, 4,4′-(1-methylethylidene)bis-, polymer with 2-(chloromethyl)oxirane (Hexion, Houston, Tex.), 100% solids.

Epon 828, Bisphenol A/Epichlorohydrin based epoxy (Shell Chemical Company, Houston, Tex.), 100% solids.

Tinuvin 123, A mixture of reaction products of decanedioic acid, bis(2,2,6,6-tetramethyl-1-(octyloxy)-4-piperidinyl)ester with 1,1-dimethylethylhydroperoxide and octane, (Ciba Specialty Chemicals, Tarrytown, N.Y.), 100% solids. (CAS Reg. No.: 129757-67-1)

Tinuvin 384-2, benzenepropanoic acid, 3-(2HBenzotriazol-2-yl)-5-(1,1-dimethylethyl)-4-hydroxy-, C₇₋₉-branched and linear alkyl esters (Ciba Specialty Chemicals, Tarrytown, N.Y.), 100% solids.

Bayhydur 302, 1,6-hexamethylenediisocyanate-based polyisocyanate (Bayer Material Science LLC. Pittsburgh, Pa.), 100%

Cymel 301, modified melamine-formaldehyde resin (Cytech Industries Inc., West Paterson, N.J.), 100% solid

Desmodur XP 2410, 1,6-hexamethylenediisocyanate-based polyisocyanate (Bayer Material Science LLC. Pittsburgh, Pa.), 100%

### Examples 1-8

The adhesive formulations were prepared by mixing the polymers, additives, and solvent, in the ratios listed in Table 1.

TABLE 1

| | Polymer | Polymer | Additive | Additive | Solvent |
|---|---|---|---|---|---|
| Example | (parts by wt) | (parts by wt) | (parts by wt) | (parts by wt) | (parts by wt) |
| 1 | Aroset 1860 | Eponex 1510 | Tinuvin 384-2 | Tinuvin 123 | Ethyl acetate |
| | (13.75) | (0.1) | (0.15) | (0.1) | (6.25) |
| 2 | Aroset 1860 | Epon 828 | Tinuvin 384-2 | Tinuvin 123 | Ethyl acetate |
| | (13.75) | (0.1) | (0.15) | (0.1) | (6.25) |
| 3 | Aroset 1860 | DER 725 | Tinuvin 384-2 | Tinuvin 123 | Ethyl acetate |
| | (13.75) | (0.1) | (0.15) | (0.1) | (6.25) |
| 4 | Aroset 1860 | Epon 828 | Tinuvin 384-2 | Tinuvin 123 | Ethyl acetate |
| | (13.75) | (0.2) | (0.15) | (0.1) | (6.25) |
| 5 | Duro-Tak | Eponex 1510 | Tinuvin 384-2 | Tinuvin 123 | Ethyl acetate |
| | 216A (12.5) | (0.1) | (0.15) | (0.1) | (7.5) |
| 6 | Duro-Tak | Epon 828 | Tinuvin 384-2 | Tinuvin 123 | Ethyl acetate |
| | 216A (12.5) | (0.1) | (0.15) | (0.1) | (7.5) |
| 7 | Duro-Tak | DER 725 | Tinuvin 384-2 | Tinuvin 123 | Ethyl acetate |
| | 216A (12.5) | (0.1) | (0.15) | (0.1) | (7.5) |
| 8 | Duro-Tak | DER 725 | Tinuvin 384-2 | Tinuvin 123 | Ethyl acetate |
| | 216A (12.5) | (0.2) | (0.15) | (0.1) | (7.5) |

The formulated adhesives were applied to fluorinated ethylene propylene (FEP) copolymer film by manual drawdown using a No. 8 Meyer rod, and then dried at 105° C. for 1 min. Dry coating thickness was 0.8-1.0 mil. A sample of ALDPET (PET film coated with aluminum oxide via atomic layer deposition) film was laminated using a Pressure Sensitive Tape Council roller at room temperature to the adhesive-coated FEP film.

The peel strength between the ALDPET and FEP layers of the as-made laminate was measured on an Instron® Universal Testing Instrument Model 1122 (Instron Worldwide, Norwood, Mass.), using 1″ strips cut from the laminated samples. The peel strength was measured using a 50 Kg loading in a 90° peel test. The free ends of ALDPET and FEP layers of the laminated sample were put into the clamps of the Instron tester and pulled in opposite directions (at an angle of 90° from the sample) at a rate of 12 inches/min. Usually a large initial tension force is required to start the peel, and a constant steady-state force is needed to propagate the peel. Testing was stopped after the clamps had moved 3″ from each other relative to their starting position. This geometry is based on ASTM D903, a standard test method for Peel or Stripping Strength of Adhesive Bonds. Results of this test for Examples 1-8 are shown in Table 2.

A multi-layer lamination sample was made by laminating a second adhesive-coated FEP film to the unlaminated side of the ALDPET layer of the ALDPET/FEP laminate to make an FEP/ALDPET/FEP laminate.

A testing sample made in such manner was subjected to the humidity simulation test at 85% humidity and 85° C. for up to 2000 hours. The laminates did not undergo significant degradation. The peel strength between ALDPET and FEP layers after heat and humidity testing are shown in Table 2 for Examples 1-8.

A 7.5 cm×7.5 cm lamination sample was tested in the UV exposure simulation test for 1200 hours, during which time the laminate did not undergo significant degradation. In this test, an Atlas Weather-Ometer® Model Ci 65 (Atlas Electric Devices Company, Chicago, Ill.) was used, which utilized a water-cooled xenon arc lamp set at 0.55 watts/m², a borosilicate outer filter, and a quartz inner filter to provide a constant source of 340 nm light. The peel strength results between the ALDPET and PET layers after UV exposure for Examples 1-8 are given in Table 2. The environmental temperature of the UV chamber was 67° C.

TABLE 2

| | | After heat and | |
|---|---|---|---|
| Example | As-made laminates | humidity testing | After UV exposure |
| 1 | 830 | 726 | 820 |
| 2 | 915 | 776 | 800 |
| 3 | 1224 | 994 | 1004 |
| 4 | 855 | 770 | 759 |
| 5 | 1283 | 869 | 709 |
| 6 | 1176 | 509 | 729 |
| 7 | 907 | 589 | 516 |
| 8 | 1278 | 393 | 516 |

### Example 9

The adhesive formulations were prepared by mixing the polymers, additives, and solvent, in the ratios listed in Table 3.

The formulated adhesive was applied to an FEP film by manual drawdown using a No. 8 Meyer rod. Dry coating thickness was 0.8-1.0 mil. Next, metalized PET was laminated to the adhesive-coated FEP film.

The peel strength between metalized PET and FEP was measured on the Instron tester and showed adhesion with initial peel strength of 655 g-force/inch. After one week, the peel strength between the metalized PET and FEP layers increased to 1269 g-force/inch. Over time, the adhesive layer became hazy.

TABLE 3

| | Polymer | Polymer | Additive | Solvent |
|---|---|---|---|---|
| Example | (parts by wt) | (parts by wt) | (parts by wt) | (parts by wt) |
| 9 | Duro-Tak 216A | Cymel 301 | p-Toluene-sulfonic | Ethyl acetate |
| | (12.5) | (0.2) | acid (0.046) | (7.914) |
| 10 | Aroset 1860 | Bayhydur 302 | — | Ethyl acetate |
| | (11) | (0.4) | | (9) |
| 11 | Duro-Tak 216A | Desmodur XP 2410 | — | Ethyl acetate |
| | (12.5) | (0.4) | | (7.5) |

### Example 10

The procedure described in Example 9 was repeated, using the formulation described in Table 3.

The peel strength between the metalized PET and FEP layers was measured on the Instron tester and showed adhesion with an initial peel strength of 406 g-force/inch. After one week, the peel strength between the metalized PET and FEP layers was 517 g-force/inch.

### Example 11

The procedure described in Example 9 was repeated, using the formulation described in Table 3.

The peel strength between the metalized PET and FEP layers was measured on the Instron tester and showed adhesion with an initial peel strength of 446 g-force/inch. After one week, the peel strength between the metalized PET and FEP layers was 677 g-force/inch.

What is claimed is:

1. A laminate article comprising:
a) a first substrate layer comprising a fluorine-containing surface;
b) a second substrate layer; and
c) an adhesive layer in contact with both the fluorine-containing surface of the first substrate layer and the second substrate layer, wherein the adhesive layer comprises:
i) a cross-linkable pressure-sensitive acrylic adhesive; and
ii) a cross-linker selected from the group consisting of epoxies, polyisocyanates, and melamines.

2. The laminate article of claim 1, wherein the first substrate layer comprises fluoropolymer films, fluoropolymer sheets or fluoropolymer-coated substrates.

3. The laminate article of claim 2, wherein the fluoropolymer is selected from the group consisting of polytetrafluoroethylene, polyvinyl fluoride, polyvinylidene fluoride, fluorinated ethylene-propylene copolymer, and polyethylenetetrafluoroethylene.

4. The laminate article of claim 1, wherein the second substrate layer comprises foamed sheets, metal sheets, fabric, polymer films or polymer sheets.

5. The laminate article of claim 4, wherein the polymer is selected from the group consisting of polyolefins, polyamides, polyimides, and polyesters.

6. The laminate article of claim 4, wherein the second substrate layer is coated with a metal, a metal oxide or a metal nitride.

7. The laminate article of claim 1, wherein the cross-linkable pressure-sensitive acylic adhesive comprises 90-99.9 wt % of one or more C₁-C₁₈ alkyl(meth)acrylic ester monomers and 0.1-10 wt % of a vinyl and/or acrylic monomer having a functional group capable of being cross-linked.

8. The laminate article of claim 7, wherein the one or more C₁-C₁₈ alkyl(meth)acrylic ester monomers are selected from the group consisting of butyl(meth)acrylate, 2-ethylhexyl(meth)acrylate, n-propyl(meth)acrylate, isopropyl(meth)acrylate, t-butyl(meth)acrylate, pentyl(meth)acrylate, n-octyl(meth)acrylate, isooctyl(meth)acrylate, and isononyl(meth)acrylate, 2-methyl butyl acrylate, amyl(meth)acrylate, hexyl(meth)acrylate, decyl(meth)acrylate, dodecyl(meth)acrylate, isodecyl acrylate, isomers and mixtures thereof.

9. The laminate article of claim 7, wherein the vinyl or acrylic monomer having a functional group capable of being cross-linked is selected from the group consisting of hydroxy-containing monomers and carboxy-containing monomers.

10. The laminate article of claim 9, wherein the hydroxy-containing monomers are selected from the group consisting of 2-hydroxyethyl(meth)acrylate, 2-hydroxypropyl(meth)acrylate, 4-hydroxybutyl(meth)acrylate, 2-hydroxyethyleneglycol(meth)acrylate, 2-hydroxypropyleneglycol(meth)acrylate, and mixtures thereof.

11. The laminate article of claim 9, wherein the carboxy-containing monomers are selected from the group consisting of acrylic acid, methacrylic acid, acrylic acid dimer, itaconic acid, maleic acid, maleic anhydride, and mixtures thereof.

12. The laminate article of claim 1, wherein the cross-linker is an epoxide selected from the group consisting of 3,4-epoxycyclohexylmethyl-3,4-epoxycyclohexane carboxylate; 3,4-epoxy-2-methylcyclohexylmethyl-3,4-epoxy-2-methycyclohexane carboxylate; bis(3,4-epoxy-6-methylcyclohexylmethyl)adipate; 3-methyl-1,5-pentanediol bis(3,4-epoxycyclohexanecarboxylate); 1,5-pentanediol bis(3,4-epoxycyclohexanecarboxylate); 2-methoxymethyl-2,4-dimethyl-1,5-pentanediol bis(3,4-epoxycyclohexanecarboxylate); ethylene glycol bis(3,4-epoxycyclohexanecarboxylate); 2,2-diethyl-1,3-propanediol bis(3,4-epoxycyclohexanecarboxylate); 1,6-hexanediol bis(3,4-epoxycyclohexanecarboxylate); 2-butene-1,4-diol bis(3,4-epoxy-6-methylcyclohexanecarboxylate); 1,1,1-trimethylolpropane tris(3,4-epoxycyclohexanecarboxylate); 1,2,3-propanetriol tris(3,4-epoxycyclohexanecarboxylate); dipropylene gylcol bis(2-ethylhexyl 4,5-epoxycyclohexane-1,2-dicarboxylate); diethylene glycol bis(3,4-epoxy-6-methylcyclohexanecarboxylate); triethylene glycol bis(3,4-epoxycyclohexanecarboxylate); 3,4-epoxycycicohexylmethyl 3,4-epoxycyclohexanecarboxylate; 3,4-epoxy-1-methylcyclohexylmethyl 3,4-epoxy-1-methyl-cyclohexanecarboxylate; 3,4-epoxy-2-methylcyclohexylmethyl 3,4-epoxy-2-methyl-cyclohexanecarboxylate; (1-chloro-3,4-epoxycyclohexan-1-yl)methyl 1-chloro-3,4-epoxycyclohexanecarboxylate; (1-bromo-3,4-epoxycyclohexan-1-yl)methyl 1-bromo-3,4-epoxycyclohexanecarboxylate; (1-chloro-2-methyl-4,5-epoxycyclohexan-1-yl)methyl 1-chloro-2-methyl-4,5-epoxycyclohexanecarboxylate; bis(3,4-epoxycyclohexylmethyl)pimelate; bis(3,4-epoxy-6-methylcyclohexylmethyl)maleate; bis(3,4-epoxy-6-methylcyclohexylmethyl)succinate; bis(3,4-epoxycyclohexylmethyl)oxalate; bis(3,4-epoxy-6-methylcyclohexylmethyl)sebacate; bis(3,4-epoxycyclohexylmethyl)terephthalate; bis(3,4-epoxy-6-methylcyclohexylmethyl)terephthalate; bis(3,4-epoxy-6-methylcyclohexylmethyl)diethylene glycol ether; 2,2′-sulfonyldiethanol bis(3,4-epoxycyclohexanecarboxylate); N,N′-ethylene bis(4,5-epoxycyclohexane-1,2-dicarboximide); di(3,4-epoxycyclohexylmethyl) 1,3 tolylenedicarbamate; bis(3,4-epoxy-6-methylcyclohexylmethyl) 3,4-epoxy-6-methylcyclohexanecarboxaldehyde acetal; vinyl cyclohexene dioxide; vinyl cyclohexene monoxide; 3,4-epoxycyclohexylmethyl acrylate; 3,4-epoxy-6-methylcyclohexylmethyl 9,10-epoxystearate; 1,2-bis(2,3-epoxy-2-methylpropoxy)ethane; 3,9-bis(3,4-epoxycyclohexyl)spiro-bi(meta-dioxane); bis(2,3-epoxycyclopentyl)ether; dicyclopentadiene dioxide; glycidyl 2,3-epoxycyclopentyl ether; 2,3-epoxycyclopentyl 2-methyl-glycidyl ether; 2,3-epoxycyclopentyl acrylate; 2,3-epoxycyclopentyl cyclopentyl ether; 2,3-epoxycyclopentyl phenyl ether; 2,3-epoxycyclopentyl 2-cyclopentenyl ether; 2,3-epoxycyclopentyl crotonate; allyl 2,3-epoxycyclopentyl ether; 2,3-epoxycyclopentanol; dicyclopentadiene monoxide; 2,2-bis-(4-hydroxyphenol)propane; copolymers of (chloromethyl)oxirane and 4,4′-(1-methylethylidene)bisphenol; butadiene dioxide; 1,4-bis(2,3-epoxypropoxy)benzene; 1,3-bis(2,3-epoxypropoxy)benzene; 4,4′-bis(2,3-epoxypropoxy)diphenyl ether; 1,8-bis(2,3-epoxypropoxy)octane; 1,4-bis(2,3-epoxypropoxy)cyclohexane; 4,4′-bis(2-hydroxy-3,4-epoxybutoxy)diphenyldimethylmethane; 1,3-bis(4,5-epoxypentoxy)-5-chlorobenzene; 1,4-bis(3,4-epoxybutoxy)-2-chlorocyclohexane; diglycidyl thioether; diglycidyl ether; ethylene glycol diglycidyl ether; resorcinol diglycidyl ether; 1,2,5,6-diepoxy-hexyne-3; 1,2,5,6-diepoxyhexane; 1,2,3,4-tetra(2-hydroxy-3,4-epoxybutoxy)butane; styrene oxide; vinylcyclohexene oxide; glycidol; glycidyl methacrylate; diglycidyl ethers of Bisphenol A; diglycidyl ethers of Bisphenol F; vinylcyclohexane dioxide; 3,4-epoxycyclohexyl-methyl-3,4-epoxycyclohexene carboxylate; 2-(3,4-epoxycyclohexyl-5,5-spiro-3,4-epoxy)cyclohexane-metadioxane; bis(3,4-epoxycyclohexyl)adipate; is dipentene dioxide; epoxidized polybutadiene; flame retardant epoxide resins; 1,4-butanediol diglycidyl ether; diglycidyl ether of hydrogenated Bisphenol A based epoxide resins; and polyglycidyl ethers of phenol-formaldehyde novolak.

13. The laminate article of claim 1, wherein the cross-linker is an isocyanate or an isocyanate derivative selected from the group consisting of tetramethylene diisocyanate; hexamethylene diisocyanate; octamethylene diisocyanate; decamethylene diisocyanate; dodecamethylene diisocyanate; tetradecamethylene diisocyanate; derivatives of lysine diisocyanate; trimethylhexane diisocyanate; tetramethylhexane diisocyanate; 1,4-, 1,3- and 1,2-diisocyanatocyclohexane; 4,4′- and 2,4′-di(isocyanatocyclohexyl)-methane; 1-isocyanato-3,3,5-trimethyl-5-(isocyanatomethyl)cyclohexane; 1,3- and 1,4-bis(isocyanatomethyl)cyclohexane; 2,4- and 2,6-diisocyanato-1-methylcyclohexane; 2,4- and 2,6-tolylene diisocyanate and isomer mixtures thereof; m- and p-xylylene diisocyanate; 2,4′- and 4,4′-diisocyanatodiphenylmethane and isomer mixtures thereof; 1,3- and 1,4-phenylene diisocyanate; 1-chloro-2,4-phenylene diisocyanate; 1,5-naphthylene diisocyanate; diphenylene 4,4′-diisocyanate; 4,4′-diisocyanato-3,3′-dimethylbiphenyl; 3-methyldiphenylmethane 4,4′-diisocyanate; tetramethylxylylene diisocyanate; 1,4-diisocyanatobenzene; diphenyl ether 4,4′-diisocyanate; polyisocyanates containing isocyanurate groups; uretdione diisocyanates; polyisocyanates containing biuret groups; polyisocyanates containing amide groups; polyisocyanates containing urethane or allophanate groups; polyisocyanates comprising oxadiazinetrione groups or iminooxadiazinedione groups; carbodiimide- or uretonimine-modified polyisocyanates of linear or branched C₄-C₂₀ alkylene diisocyanates; cycloaliphatic diisocyanates having a total of 6 to 20 carbon atoms; aromatic diisocyanates having a total of 8 to 20 carbon atoms; and mixtures thereof.

14. The laminate article of claim 1, wherein the cross-linker is a melamine resin obtained by reacting melamine with an aldehyde selected from the group consisting of formaldehyde, acetaldehyde, isobutyraldehyde and glyoxal.

15. The laminate of claim 1, further comprising additives selected from the group consisting of plasticizers, tackifiers, solvents, wetting agents, pigments, antioxidants, ultraviolet absorbers, antistatic agents, lubricants, fillers, opacifying agents, anti-foam agents, and heat- and light-stabilizers.
